(19) United States
(12) Patent Application Publication
(10) Pub. No.: US 2010/0245060 A1
(43) Pub. Date: Sep. 30, 2010

(54) Method and Apparatus Pertaining to Doorbell Chimes

(76) Inventors: Scott Blaise Tylicki, Bowling Green, KY (US); Timothy Gale Birdwell, Lafayette, TN (US); Jimmy David Claiborne, Scottsville, KY (US)

Correspondence Address: FITCH EVEN TABIN & FLANNERY, 120 SOUTH LASALLE STREET, SUITE 1600, CHICAGO, IL, 60603-3406, US

(21) Appl. No.: 12/415,398

(22) Filed: Mar. 31, 2009

(51) Int. Cl. G08B 3/00

(52) U.S. Cl. 340/393.3

(57) ABSTRACT

A doorbell chime apparatus has an audio transducer that is responsive to both a wired-doorbell button input and a wireless-doorbell button input. Each of these inputs can respond, if desired, to a plurality of corresponding doorbell buttons. By one approach, the audio transducer can provide any of a plurality of selectable differentiated audible sounds. So configured, the resultant apparatus can provide a differentiated audible signal regarding which of the plurality of doorbell buttons is being annuciated. These teachings will accommodate providing a mains-dependent power input that provides operating power to at least one of the wired-doorbell button input and the wireless-doorbell button input. These teachings will also accommodate, in lieu of the foregoing or in combination therewith, providing a mains-supplemental power input that provides operating power to at least one of the wired-doorbell button input and the wireless-doorbell button input (at least when mains power is absent).

### TECHNICAL FIELD

This invention relates generally to doorbell chimes.

### BACKGROUND

Doorbell chimes of various kinds are known in the art. Generally speaking, a doorbell chime responds to assertion of a doorbell button by a visitor at a corresponding door by providing an alert signal. This alert signal typically comprises, at least in part, an audible signal. In some cases a mechanical mechanism (such as a bell and striker arrangement) provides this audible signal. In other cases an electronic playback apparatus provides this audible signal.

In many cases the doorbell button connects to the doorbell chime via a wired connection. This approach has been favored when installing the doorbell chime in new construction settings. In other cases, the doorbell button connects to the doorbell chime via a wireless connection to accommodate, for example, retrofitting of the doorbell chime in an existing building.

Prior art practices in these regards are useful in a number of application settings. This is not to say, however, that existing approaches prove fully satisfactory in all application settings. These existing doorbell chime arrangements present potential disadvantages and compromises that can ultimately prove inappropriate or inconvenient for use in a given setting. This, in turn, can lead to installer, homeowner, or end user dissatisfaction.

### BRIEF DESCRIPTION OF THE DRAWINGS

The above needs are at least partially met through provision of the method and apparatus pertaining to doorbell chimes described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention; and

FIG. 4 comprises a schematic/block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a doorbell chime apparatus has an audio transducer that is responsive to both a wired-doorbell button input and a wireless-doorbell button input. By one approach, each of these inputs can respond, if desired, to a plurality of corresponding doorbell buttons. Also if desired, and by one approach, the audio transducer can provide any of a plurality of selectable differentiated audible sounds. In this case, the played audible sound can correlate to whether the audio transducer is presently responding to the wired-doorbell button input or the wireless-doorbell button input. Also if desired, the particular audible sound played can correlate to whichever doorbell button has been played regardless of which input interfaces with that doorbell button. So configured, the resultant apparatus can provide a differentiated audible signal regarding which of the plurality of doorbell buttons is being annunciated.

By one approach, these teachings will accommodate providing a mains-dependent power input that provides operating power to at least one of the wired-doorbell button input and the wireless-doorbell button input. These teachings will also accommodate, in lieu of the foregoing or in combination therewith, providing a mains-supplemental power input that provides operating power to at least one of the wired-doorbell button input and the wireless-doorbell button input (at least when mains power is absent).

So configured, these teachings provide great flexibility with respect to installation and configuration options. For example, these teachings will readily accommodate both new-construction conditions as well as retrofitting circumstances. These teachings also offer great flexibility with respect to power requirements. In particular, these teachings will readily accommodate the use of existing mains-based power when available but will also foster satisfactory results in the (temporary or permanent) absence of mains-based power. Those skilled in the art will further appreciate that these teachings are highly scalable and can be employed with any number of doorbell buttons, annunciation sounds, and so forth.

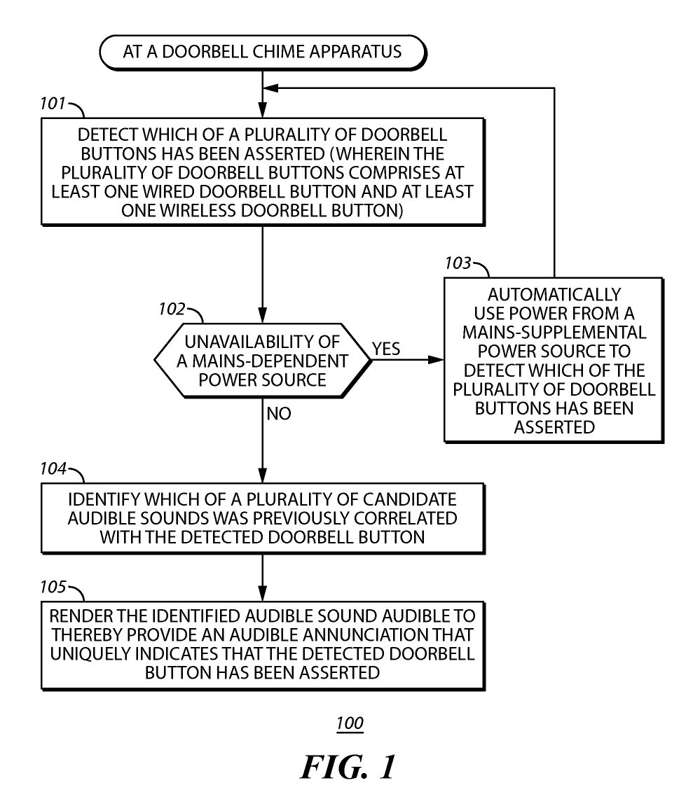

These and other benefits may become clearer upon making a thorough review and study of the following detailed description. Referring now to the drawings, and in particular to FIG. 1, an illustrative process 100 that is compatible with many of these teachings will now be presented. As noted, a doorbell chime apparatus carries out this process 100. As used herein, this reference to a “doorbell chime apparatus” will be understood to comprise an integrated platform that includes a native capability to carry out the described steps in a self-sufficient manner without relying upon other outboard components. This integrated platform will be understood to comprise a single housing that houses the entirety of the platform with the possible exception of a transformer (and related components) to reduce an external mains voltage supply to a lesser voltage (such as 16 volts).

This process 100 provides the step 101 of detecting which of a plurality of doorbell buttons has been asserted (by, for example, a visitor at a corresponding door). As used herein, this reference to a “button” will be understood to refer to the standard push-to-activate doorbell button along with other mechanisms by which a visitor can indicate their presence such as, but not limited to, touch-screen displays, proximity detectors, biometric readers, and so forth. This plurality of doorbell buttons comprises at least one wired doorbell button (meaning that the doorbell button connects to the doorbell chime apparatus via a non-wireless conduit such as an electrical conductor (such as one or more wires of copper or the like), an optical conductor (such as an optical fiber), and so forth) and at least one wireless doorbell button (meaning that the doorbell button communicates with the doorbell chime apparatus via a wireless pathway such as via radio-frequency transmissions, optical-frequency transmissions, audible-frequency transmissions, and so forth).

This step 101 will readily accommodate detecting assertion of any of a plurality of wired doorbell buttons and/or a plurality of wireless doorbell buttons, if desired. At a minimum, however, this step 101 comprises detecting assertions from amongst a pool of candidate doorbells where at least one of the candidates is a wired doorbell button and at least one of the candidates is a wireless doorbell button.

In at least some application settings, this step 101 of detecting doorbell button assertions will comprise using power from a mains-dependent power source to detect which of doorbell buttons has been asserted. (The expression “mains” will be understood to refer to a supply of general purpose alternating current (AC) electrical power. Other common expressions for such a supply are household power, household electricity, domestic power, wall power, line power, AC power, city power, and grid power. The expression “mains-dependent” will be understood to refer to a supply of AC electrical power that relies, moment to moment, upon the concurrent availability of mains power such that the mains-dependent power is absent in the absence of the mains power.) As will be shown below, for example, this can comprise using such power to directly detect the assertion of a wired doorbell button and/or to power a wireless receiver that receives transmissions from a wireless doorbell button.

In such a case, a possibility exists that mains power will be unavailable. This can occur, for example, due to a wide-area power outage or simply because mains-based power is unavailable at the point of installation. To accommodate such a situation, and if desired, this process 100 can comprise the step 102 of detecting such unavailability and responding with step 103 by substituting the use of power from a mains-supplemental power source to detect doorbell assertion. This can comprise, as desired, a complete substitution of mains-dependent power for all of the doorbell buttons or for only some selected subset thereof. (As used herein, the expression “mains supplemental” will be understood to refer to a source of power that remains locally available notwithstanding an absence of mains power.)

This mains-supplemental power source can comprise, for example, one or more batteries. This battery can be rechargeable, or not, as desired. When using a rechargeable battery, these teachings will readily accommodate also using a recharger to maintain the battery in at least a relatively fully-charged state pending use. Further details in such regards are presented further below.

In any event, this process 100 also includes the step 104 of identifying which of a plurality of candidate audible sounds was previously correlated with the detected doorbell button to provide a corresponding identified audible sound. (As used herein, the expression “candidate” will be understood to refer to selections that are genuinely and substantively presently available at the doorbell chime apparatus for selectable and immediate use.) These audible sounds can comprise any of (including a mixing and matching of):

Mechanically-formed sounds (formed, for example, by striking tuned resonant elements (such as bells, bars, and tubular bells)); and/or

Electronically-formed sounds (formed, for example, by processing Musical Instrumental Digital Interface (MIDI)-based musical information or by playing back an audio file such as an MP3 or WAV-encoded audio file).

The referred-to correlation can be stored in a hard-wired configuration if desired. Using this approach, assertion of a given one of the doorbell buttons ultimately completes a circuit that yields only a given one of the available audible sounds. This correlation can also be stored, if desired, in a look-up table. The following table comprises a non-limiting example of such a look-up table.

TABLE 1

| | |
|---|---|
| Wired doorbell button 1 | MP3-encoded file 1 |
| Wired doorbell button 2 | MP3-encoded file 2 |
| Wireless doorbell button 1 | MP3-encoded file 3 |
| Wireless doorbell button 2 | MP3-encoded file 4 |
| Wireless doorbell button 3 | MP3-encoded file 5 |

In the foregoing example, the table accommodates five doorbell buttons, two being wired doorbell buttons and three being wireless doorbell buttons. This table correlates each button with a different, corresponding audible sound (in this case, a different MP3-encoded audio file).

This process 100 then concludes with the step 105 of rendering this identified audible sound audible. This, in turn, permits the doorbell chime apparatus to provide an audible annunciation that uniquely identifies whichever doorbell button a given visitor asserts. Those skilled in the art will recognize and appreciate that such an approach permits a given doorbell chime apparatus to detect and appropriately respond to a plurality of doorbell buttons regardless of how many of those doorbell buttons are wired and how many are wireless. Such a capability permits such an apparatus to be readily utilized in a virtually unlimited number of application settings including both new-construction settings as well as remodeling and retrofitting settings.

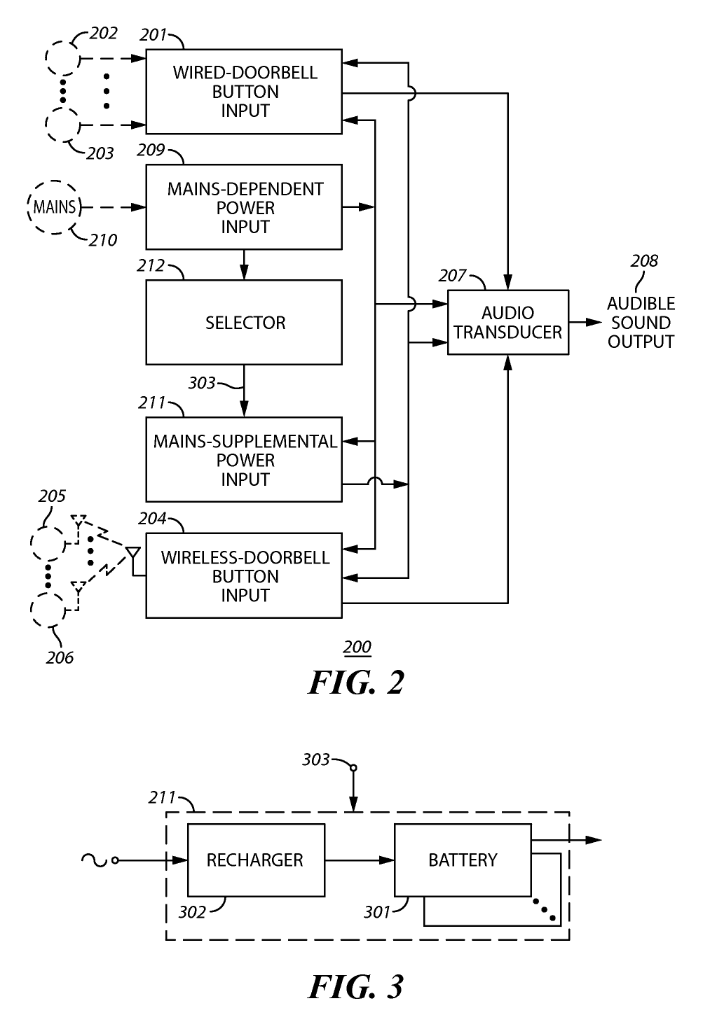

Those skilled in the art will appreciate that the above-described processes are readily enabled using a readily configured platform, including partially or wholly programmable platforms as are known in the art or dedicated purpose platforms as may be desired for some applications. Referring now to FIG. 2, an illustrative approach to such a platform will now be provided.

In this illustrative example, a doorbell chime apparatus 200 includes a wired-doorbell button input 201 that operably interfaces (for example, via corresponding electrical wiring) to one or more wired doorbell buttons 202 and 203. By one approach, this wired-doorbell button input 201 comprises a common input and interface (that is, a shared input/interface) for a plurality of wired doorbell buttons. Such an approach may serve, for example, when the plurality of wired doorbell buttons communicates with the doorbell chime apparatus 200 via a serial bus (in which case, the wired-doorbell button input 201 can comprise, at least in part, a wired serial-bus interface).

This doorbell chime apparatus 200 also includes a wireless-doorbell button input 204 that wirelessly interfaces (for example, via Radio Frequency (RF) transmissions, optical frequency transmissions, sub-audible or super-audio frequency transmissions, and so forth) to one or more wireless doorbell buttons 205 and 206. This wireless-doorbell button input 204 can comprise, for example, a wireless receiver of choice. As with the wired-doorbell button input 201, this wireless-doorbell button input 204 can be responsive to any of a plurality of wireless doorbell buttons if desired. By one approach, each of these wireless doorbell buttons can communicate with the wireless-doorbell button input 204 using a shared channel. By another approach, if desired, these wireless doorbell buttons can each utilize a uniquely assigned communication resource (such as a reserved portion of a shared carrier frequency, a uniquely-assigned spreading code as used with a shared frequency band, or even a reserved carrier frequency, to note but a few examples in these regards).

In this illustrative example, the doorbell chime apparatus 200 has an audio transducer 207 that operably couples to both the wired-doorbell button input 201 and the wireless-doorbell button input 204 to yield an audible sound output 208 upon detecting assertion of one of the doorbell buttons 202, 203, 205, and 206. By one approach, this audible sound output 208 can be the same regardless of which of the doorbell buttons is asserted. By another approach, and as noted above, this audio transducer 207 can have predefined differentiated audible sounds. In such a case, the audio transducer 207 can provide a differentiated audible sound regarding which of the plurality of doorbell buttons is being annunciated. By yet another approach, and as noted above, this audio transducer 207 can have present access to a plurality of selectable differentiated audible sounds. In such a case, the audio transducer 207 can provide a differentiated audible sound regarding which of the plurality of doorbell buttons is being annunciated.

So configured, those skilled in the art will recognize and appreciate that this one audio transducer is responsive to both the wired-doorbell button input 201 and the wireless-doorbell button input 204. Accordingly, this one audio transducer is therefore responsive to both wired doorbell buttons and wireless doorbell buttons. Although such an approach is highly contrary to prior art practice in these regards, the applicant has determined that such a configuration yields certain benefits including the ability to operate with any of a wide variety of available already-installed and retro-installable doorbell buttons.

By one approach, and as illustrated in FIG. 2, this doorbell chime apparatus 200 can also comprise a mains-dependent power input 209 that provides operating power to, for example, the wired-doorbell button input 201 and/or the wireless-doorbell button input 204 (as well as other components such as the aforementioned audio transducer 207 as desired). This mains-dependent power input 209 connects to a source of mains power 210. In a residential application setting in the United States, for example, this will typically comprise household power of about 110 to 120 volts at 60 Hz that may, or may not, be stepped down to a lower voltage such as the relatively ubiquitous sixteen volts AC via an intervening power transformer (not shown).

By one approach, and also as illustrated in FIG. 2, this doorbell chime apparatus 200 can also comprise a mains-supplemental power input 211 that can also provide operating power to one or both of the wired-doorbell button input 201 and the wireless-doorbell button input 204 (and other components, such as the audio transducer 207 as desired). With momentary reference to FIG. 3, this mains-supplemental power input 211 can comprise at least one battery 301. This battery 301 (or two or more such batteries when a plurality of batteries are employed) can comprise a non-rechargeable battery (that is, a battery that is ordinarily designed and sold without being intended or identified as being rechargeable) if desired.

Or, if desired, this mains-supplemental power input 211 can comprise a rechargeable battery. When using one or more rechargeable batteries, this mains-supplemental power input 211 can also comprise, if desired, a recharger 302. Such a recharger 302 can serve to automatically use mains power 210 (via, for example, the aforementioned mains-dependent power input 209) to recharge the battery(s).

When using both mains power and mains-supplemental power, it may be useful to permit an automated selection between such sources. To accommodate such an approach, the mains-supplemental power input 211 can be made responsive to a selection signal 303. For example, in the presence of such a selection signal 303 the mains-supplemental power input 211 can provide power at its output. Conversely, in the absence of the selection signal 303 such power can be withheld.

To facilitate the selective provision of such a selection signal 303, and referring again to FIG. 2, the doorbell chime apparatus 202 can also comprise a selector 212. This selector 212 can operably couple to the mains-dependent power input 209 to detect when the latter fails to provide operating power (as may occur, for example, when the mains power source 210 fails for whatever reason). Upon detecting such a condition, this selector 212 can modify the selection signal 303 accordingly to thereby switch the powered components from the mains-dependent power input 209 to the mains-supplemental power input 211. So configured, the selector 212 controls when the two doorbell button inputs 201 and 204 receive operating power from the mains-dependent power input 209 and the mains-supplemental power input 211.

Those skilled in the art will recognize that these teachings are readily implemented using a variety of architectural approaches. For example, by one approach, the components of FIG. 2 can be viewed as comprising physical components that are configured and interconnected as described. As another example, FIG. 2 can be viewed as a logical diagram that serves as a guide to programming a corresponding programmable platform. For the sake of illustration and without intending any limitations in these regards, a more specific instantiation of such a doorbell chime apparatus will now be presented.

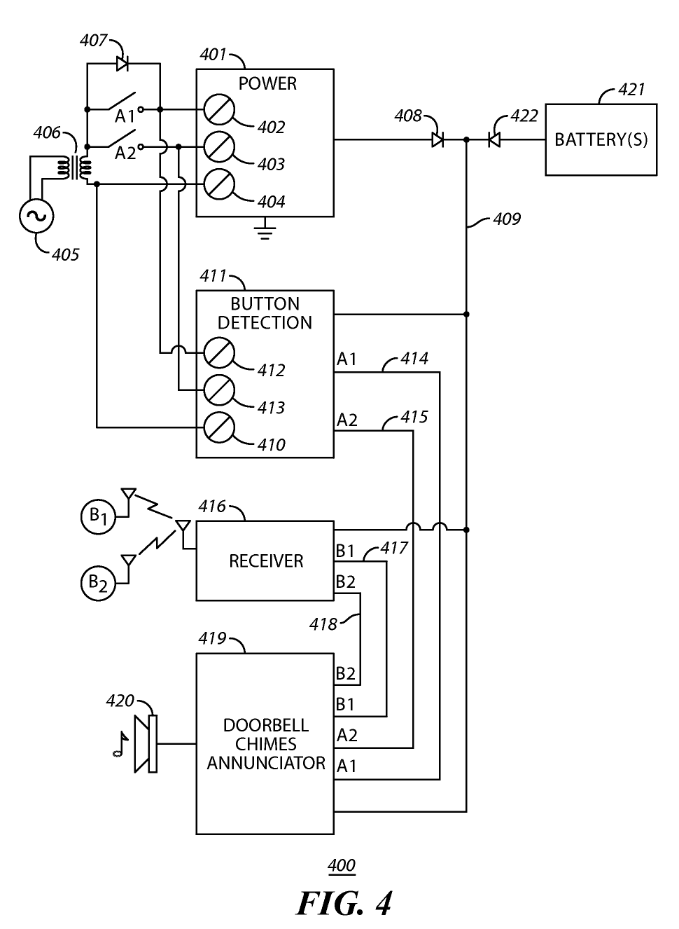

Referring now to FIG. 4, in this illustrative example the doorbell chime apparatus 400 has a first terminal block 401 having three screw terminals 402, 403, and 404. The first screw terminal 402 couples to the secondary of a power transformer 406 via a diode 407. The primary side of this power transformer 406 connects to a mains power source 405. This power transformer 406 steps down the mains voltage to twenty-four volts. In this example, the first terminal block 401 comprises an inverter that converts the incoming AC power to a direct current (DC) power signal having a voltage such as three volts, six volts, nine volts, or the like. The first terminal block 401 provides this DC output via a diode 408 to a power bus 409.

The first screw terminal 402 also connects to a first wired doorbell button Al while the second screw terminal 403 connects to a second wired doorbell button A2. Those skilled in the art will recognize that any number of additional wired doorbell buttons can be accommodated by providing a corresponding number of additional screw terminals and that only two wired doorbell buttons are shown here for the sake of clarity and simplicity. The third screw terminal 404, in turn, couples to the secondary of the transformer 406 and to a third screw terminal 410 of a second terminal block 411 that serves as a doorbell button detector.

The first screw terminal 412 of this second terminal block 411 connects to the first screw terminal 402 of the first terminal block 401. Similarly, the second screw terminal 412 of the second terminal block 411 connects to the second screw terminal 403 of the first terminal block 401.

So configured, the second terminal block 411 is configured to detect when one of the wired doorbell buttons Al and A2 closes. This can essentially comprise just comparing the signal appearing at the corresponding screw terminal 412 and 413 against some corresponding and appropriate threshold value. For example, when button Al is open a half-wave rectified signal appears at the corresponding terminal but when button Al is closed a full AC waveform appears at this terminal. This, in turn, permits the second terminal block 411 to provide an A1 detected output 414 and an A2 detected output 415 as A1 and A2 close, respectively.

In this illustrative embodiment the doorbell chime apparatus 400 also includes a wireless receiver 416 that receives wireless signals from corresponding wireless doorbell buttons B 1 and B2 regarding their assertion states. As with the wired doorbell buttons discussed above, those skilled in the art will recognize that such a receiver 416 could accommodate more than two such wireless doorbell buttons and that only two doorbell buttons are shown here for the sake of clarity and simplicity. It will also be understood that, if desired, a separate receiver could be provided for each individual wireless doorbell button. This receiver 416, in turn, provides a B1 detected output 417 and a B2 detected output 418 as B1 and B2 close, respectively.

The various aforementioned detected outputs 414, 415, 417, and 418 are provided to a doorbell chimes annunciator 419 that drives one or more speakers 420 to provide a corresponding audible output. As described above, this can comprise a selected output that varies with each of the doorbell buttons such that the doorbell chime annunciator 419 audibilizes a different sound for each of the different doorbell buttons. It would also be possible, of course, to reuse a given sound for two or more of these doorbell buttons if desired.

As shown, the second terminal block 411, the receiver 416, and the doorbell chimes annunciator 419 all draw operating power from the aforementioned power bus 409. If desired, one or more batteries 421 can also couple to this power bus 409 via a diode 422. So long as the first terminal block 401 provides mains-based power to the power bus 409, this diode 422 will prevent the battery(s) 421 from being drawn upon. If and when the mains power source 405 should fail, however, this diode 422 will become forward biased and the power bus 409 will now draw power from the battery(s) 421. This, in turn, will continue to support the button detection functionality and the audio processing functionality of these components. (It will be understood that such an architecture could readily accommodate a battery recharger as described above to maintain the battery(s) 421 in a freshly-charged state. For the sake of clarity and simplicity such a recharger is not shown here.)

The illustrative example provided above comports well with the approach often taken, in part, with some prior art doorbell chime apparatuses. It will be understood, however, that other architectural approaches can be taken as well. For example, if desired, a microprocessor, microcontroller, or digital signal processor approach (or the like) can serve to effect some or virtually all of the described steps, actions, and functionality set forth herein.

So configured, those skilled in the art will appreciate that these teachings will readily accommodate essentially all application settings that might benefit from a doorbell chime using a single enabling platform. This includes both wired and wireless doorbell buttons. These teachings also accommodate a variety of power scenarios and permit such a platform to work in conjunction with existing mains-based power when available or to remain functional notwithstanding the temporary or permanent absence of mains-based power. Skilled artisans will further appreciate that these teachings are highly scalable and will readily accommodate a wide range and number of doorbell buttons, communication links, and audible sounds.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A doorbell chime apparatus comprising:
a wired-doorbell button input;
a wireless-doorbell button input;
an audio transducer that is responsive to both the wired-doorbell button input and the wireless-doorbell button input and having an audible sound output.

2. The doorbell chime apparatus of claim 1 wherein the wired-doorbell button input comprises a common input for a plurality of wired doorbell buttons.

3. The doorbell chime apparatus of claim 2 wherein the audio transducer provides a plurality of selectable differentiated audible sounds to thereby provide a differentiated audible signal regarding which of the plurality of wired-doorbell buttons is being annunciated.

4. The doorbell chime apparatus of claim 1 wherein the wireless-doorbell button input comprises a wireless receiver.

5. The doorbell chime apparatus of claim 4 wherein the wireless receiver is responsive to any of a plurality of wireless-doorbell buttons.

6. The doorbell chime apparatus of claim 5 wherein the audible sound output provides a plurality of selectable differentiated audible sounds to thereby provide a differentiated audible signal regarding which of the plurality of wireless-doorbell buttons is being annunciated.

7. The doorbell chime apparatus of claim 1 wherein the audible sound output provides a plurality of selectable differentiated audible sounds to thereby provide a differentiated audible signal regarding which of a wired-doorbell button and a wireless-doorbell button is being annunciated.

8. The doorbell chime apparatus of claim 7 wherein
the wired-doorbell button input is responsive to a plurality of wired-doorbell buttons;
the wireless-doorbell button input is responsive to a plurality of wireless-doorbell buttons;
the audible sound output provides a plurality of selectable differentiated audible sounds to thereby provide a differentiated audible signal regarding which of the plurality of wired and wireless-doorbell buttons is being annunciated.

9. The doorbell chime apparatus of claim 1 further comprising:
a mains-dependent power input that provides operating power to at least one of the wired-doorbell button input and the wireless-doorbell button input.

10. The doorbell chime apparatus of claim 9 wherein the mains-dependent power input provides operating power to both the wired-doorbell button input and the wireless-doorbell button input.

11. The doorbell chime apparatus of claim 1 further comprising:
a mains-supplemental power input that provides operating power to at least one of the wired-doorbell button input and the wireless-doorbell button input.

12. The doorbell chime apparatus of claim 11 wherein the mains-supplemental power input provides the operating power at least when a mains-dependent power source fails to provide the operating power.

13. The doorbell chime apparatus of claim 11 wherein the mains-supplemental power input provides operating power to both the wired-doorbell button input and the wireless-doorbell button input.

14. The doorbell chime apparatus of claim 11 wherein the mains-supplemental power input comprises, at least in part, at least one battery.

15. The doorbell chime apparatus of claim 14 wherein the at least one battery comprises a non-rechargeable battery.

16. The doorbell chime apparatus of claim 14 wherein the at least one battery comprises a rechargeable battery.

17. The doorbell chime apparatus of claim 1 further comprising:
a mains-dependent power input that provides operating power to at least one of the wired-doorbell button input and the wireless-doorbell button input;
a mains-supplemental power input that provides operating power to at least one of the wired-doorbell button input and the wireless-doorbell button input.

18. The doorbell chime apparatus of claim 17 wherein:
the mains-dependent power input provides operating power to both the wired-doorbell button input and the wireless-doorbell button input;
the mains-supplemental power input provides operating power to both the wired-doorbell button input and the wireless-doorbell button input.

19. The doorbell chime apparatus of claim 18 further comprising:
a selector that controls when at least one of the wired-doorbell button input and the wireless-doorbell input receives operating power from at least one of the mains-dependent power input and the mains-supplemental power input.

20. A doorbell chime apparatus comprising:
a wireless receiver;
an input electrically coupled in series with a doorbell button and a mains power transformer;
a doorbell chimes annunciator that provides an audible chimes annunciation in response to either of the wireless receiver and the doorbell button.

21. The doorbell chime apparatus of claim 20 wherein the wireless receiver is responsive to a wireless doorbell button.

22. The doorbell chime apparatus of claim 20 wherein the doorbell chimes annunciator is configured to provide a different audible chimes annunciation depending upon whether the doorbell chimes annunciator is responding to the wireless receiver or the doorbell button.

23. The doorbell chime apparatus of claim 20 wherein the wireless receiver is connected to receive operating power from the mains power transformer.

24. The doorbell chime apparatus of claim 23 further comprising:
a mains-supplemental power supply that is connected to provide operating power to the wireless receiver, the input, and the doorbell chimes annunciator when mains power is absent so that the doorbell chimes annunciator continues to provide the audible chimes annunciations in response to either of the wireless receiver and the doorbell button even when the mains power is absent.

25. The doorbell chime apparatus of claim 24 wherein the mains-supplemental power supply comprises at least one battery.

26. A doorbell chime apparatus comprising:
at least one doorbell-button interface;
a doorbell chimes annunciator that is responsive to the doorbell-button interface;
a mains-dependent power source that provides operating power to both the at least one doorbell-button interface and the doorbell chimes annunciator;
a mains-supplemental power source that provides operating power to both the at least one doorbell-button interface and the doorbell chimes annunciator, at least when the mains-dependent power source fails to provide operating power thereto.

27. The doorbell chime apparatus of claim 26 wherein the main-dependent power source couples to a power transformer that is connected to a mains power source.

28. The doorbell chime apparatus of claim 27 wherein the power transformer provides approximately 24 volts at its secondary winding.

29. The doorbell chime apparatus of claim 26 wherein the mains-supplemental power source comprises at least one battery that sources at least some of the operating power.

30. The doorbell chime apparatus of claim 29 wherein the mains-supplemental power source further comprises a battery recharger that utilizes mains power to recharge the at least one battery.

31. The doorbell chime apparatus of claim 30 wherein the battery recharger receives the mains power via the mains-dependent power source.

32. The doorbell chime apparatus of claim 26 wherein the at least one doorbell-button interface comprises a wired-doorbell button input.

33. The doorbell chime apparatus of claim 32 wherein the at least one doorbell-button interface further comprises a wireless-doorbell button input.

34. The doorbell chime apparatus of claim 33 wherein the doorbell chimes annunciator provides a plurality of selectable differentiated audible sounds to thereby provide a differentiated audible signal regarding which of the wired-doorbell button and the wireless-doorbell button is being annunciated.

35. A method comprising:
at a doorbell chime apparatus:
detecting which of a plurality of doorbell buttons has been asserted, wherein the plurality of doorbell buttons comprises at least one wired doorbell button and at least one wireless doorbell button, to provide a detected doorbell button:
identifying which of a plurality of candidate audible sounds was previously correlated with the detected doorbell button to provide an identified audible sound;
rendering the identified audible sound audible to thereby provide an audible annunciation that uniquely indicates that the detected doorbell button has been asserted.

36. The method of claim 35 wherein the at least one wired doorbell button comprises a plurality of wired doorbell buttons.

37. The method of claim 35 wherein the at least one wireless doorbell button comprises a plurality of wireless doorbell buttons.

38. The method of claim 35 detecting which of a plurality of doorbell buttons has been asserted comprises, at least in part, using power from a mains-dependent power source to detect which of the plurality of doorbell buttons has been asserted.

39. The method of claim 38 further comprising:
upon detecting unavailability of the mains-dependent power source, automatically using power from a mains-supplemental power source to detect which of the plurality of doorbell buttons has been asserted.

40. The method of claim 39 further comprising:
using the mains-dependent power source to automatically recharge the mains-supplemental power source.
